(19) United States
(12) Patent Application Publication
(10) Pub. No.: US 2016/0118688 A1
(43) Pub. Date: Apr. 28, 2016

(54) SODIUM ION SECONDARY BATTERY

(71) Applicant: Toyota Jidosha Kabushiki Kaisha, Toyota-shi Aichi-ken (JP)

(72) Inventor: Shinji Nakanishi, Mishima-shi (JP)

(21) Appl. No.: 14/880,015

(22) Filed: Oct. 9, 2015

(30) Foreign Application Priority Data
Oct. 27, 2014 (JP) 2014-218631

(51) Int. Cl. H01M 10/0567; H01M 10/0568; H01M 4/58; H01M 10/054

(52) U.S. Cl. CPC H01M 10/0567; H01M 10/054; H01M 10/0568; H01M 4/5825; H01M 2220/20; H01M 2300/0025

(57) ABSTRACT

Provided is a sodium ion secondary battery excellent in a cycle characteristic. A sodium ion secondary battery includes a cathode, an anode and an electrolytic solution, wherein the cathode includes a composite oxide including Na as a cathode active material, and a boron compound selected from a compound represented by the following general formula (1) and trifluoroborane is added to the electrolytic solution.

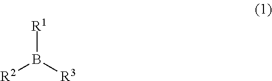

(In the formula (1), R¹, R² and R³ are independently a C₁-C₆ hydrocarbon group a part of which may be substituted by fluorine.)

### TECHNICAL FIELD

The present disclosure relates to a sodium ion secondary battery excellent in a cycle characteristic.

### BACKGROUND ART

Researches on sodium ion secondary batteries have been carried out in order to apply them to large-sized on-vehicle power sources and the like. For example, JP 2013-048077 A discloses adding, to an electrolytic solution, a saturated cyclic carbonate having a fluoro group as an additive, in order to improve a cycle characteristic of a sodium ion secondary battery. In JP 2013-048077 A, it is said that: during initial charging, the additive is reduced and decomposed on a surface of the anode to form a coating on the surface of the anode; because of the coating, decomposition of the non-aqueous solvent is inhibited, whereby degradation of the capacity can be inhibited. A technique of adding an additive to an electrolytic solution of a lithium ion secondary battery is also known, as disclosed in JP 2013-218967 A. JP 2004-265786 A discloses an electrochemically stable ion electrolyte material.

### SUMMARY

### Technical Problem

As described in JP 2013-048077 A, it is known that repeated charging and discharging of a sodium ion secondary battery can cause degradation in the capacity (degradation of cycle characteristic). Having conducted intensive researches, the inventor of the present disclosure has found the following as the way that the cycle characteristic degrades: when a sodium ion secondary battery is repeatedly charged and discharged, especially when charged, the pH in the electrolytic solution gradually degrades (acid gradually increases) along with oxidation decomposition and the like of the electrolytic solution around the cathode. That is, it is presumed that the degradation of the cycle characteristic of the sodium ion secondary battery is affected by degradation of the cathode active material, caused by the acid which gradually decomposes the cathode active material in the cathode along with repeated charging and discharging. This problem of degradation of the cycle characteristic is noticeable especially when a high voltage type cathode active material is used. The technique disclosed in JP 2013-048077 A to be applied for an anode cannot solve this problem of degradation of cycle characteristic caused by degradation of a cathode.

An object of the present disclosure is to provide a sodium ion secondary battery excellent in a cycle characteristic.

### Solution to Problem

In order to solve the above problem, the present disclosure takes the following structure. That is, the present disclosure is a sodium ion secondary battery including a cathode,

an anode, and an electrolytic solution, wherein the cathode includes a composite oxide including Na as a cathode active material, and one or more kinds of boron compound selected from a compound represented by the following general formula (1) and trifluoroborane is added to the electrolytic solution.

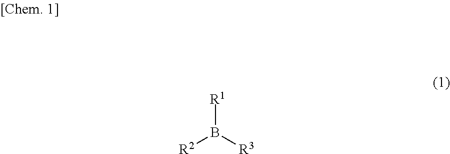

(In the formula (1), R¹, R² and R³ are independently a C₁-C₆ hydrocarbon group a part of which may be substituted by fluorine.)

In the present disclosure, the “composite oxide including Na” represents an oxide including Na and a metal element other than Na (transition metal element and the like) and/or a nonmetallic element (P, S and the like). The “electrolytic solution” represents a liquid including at least a solvent and an electrolyte salt.

In the present disclosure, it is preferable that no less than 0.001 mol/L and no more than 0.2 mol/L of the boron compound is added in the electrolytic solution. The expression “no less than 0.001 mol/L and no more than 0.2 mol/L of the boron compound is added in the electrolytic solution” means that, on the basis of the electrolytic solution where the above-mentioned boron compound is added (setting the solution as 1 L), no less than 0.001 mol and no more than 0.2 mol of the above-mentioned boron compound is added to the electrolytic solution.

In the present disclosure, it is preferable that the boron compound is one or more kinds selected from trispentafluorophenylborane, trimethylborane, triphenylborane, triethylborane, and trifluoroborane.

In the present disclosure, it is preferable that the cathode active material reaches 4.0 V or more of cathode potential in terms of sodium electrode potential in charging.

In the present disclosure, it is preferable that the cathode active material includes at least one of Co, Ni and Mn.

In the present disclosure, it is preferable that the cathode active material includes at least one of PO₄, P₂O₇ and SO₄, and it is especially preferable that the cathode active material is Na₄M₃(PO₄)₂P₂O₇ (M is at least one of Fe, Ni, Co and Mn).

In the present disclosure, it is preferable that the electrolytic solution includes NaPF₆ or NaBF₄ as an electrolyte salt.

### Advantageous Effects

In the present disclosure, a predetermined boron compound is added to the electrolytic solution. In this case, the boron compound is adsorbed to the cathode (especially to the cathode active material) or binds with acid in the electrolytic solution. Thus the cathode can be protected from the acid in the electrolytic solution. Therefore, the degradation of the cathode can be inhibited when charging and discharging are repeated. That is, according to the present disclosure, a sodium ion secondary battery excellent in a cycle characteristic can be provided.

### DESCRIPTION OF EMBODIMENTS

The sodium ion secondary battery according to the present disclosure includes a cathode, an anode and an electrolytic solution, wherein the cathode includes a composite oxide including Na as a cathode active material, and a predetermined boron compound is added to the electrolytic solution.

### 1. Cathode

The cathode includes a cathode active material. More specifically, in addition to the cathode active material, the cathode includes a cathode layer which can optionally include an electroconductive material and a binder. Further, the cathode is normally provided with a cathode current collector.

### 1.1. Cathode Active Material

The cathode active material is a composite oxide including Na, and any known cathode active material for sodium ion secondary batteries can be employed. The “composite oxide including Na” represents an oxide including Na and a metal element other than Na (transition metal element and the like) and/or a nonmetallic element (P, S and the like). Examples thereof include layered compounds, spinel compounds, polyanion compounds and the like. Specifically, any known cathode active materials such as: NaₓMO₂ (0<x≦1, M is at least one kind of Fe, Ni, Co, Mn, V and Cr) as a layered compound or a spinel compound; Na₃V₂(PO₄)₃, Na₂Fe₂(SO₄)₃, NaFePO₄, NaFeP₂O₇, Na₂MP₂O₇ (M is at least one of Fe, Ni, Co and Mn) and Na₄M₃(PO₄)₂P₂O₇ (M is at least one of Fe, Ni, Co and Mn) as a polyanion compound can be employed.

When a sodium ion secondary battery having a high-potential cathode active material is charged, if the battery reaches a high potential, for example 4.0 V or more, acid noticeably increases along with oxidation decomposition of the electrolytic solution, which easily causes degradation of the cathode. In contrast, the present disclosure inhibits the degradation of the cathode caused by charging and discharging, by addition of the boron compound described later, to the electrolytic solution. Therefore, the present disclosure improves the cycle characteristic of a sodium ion secondary battery, and has a remarkable effect when provided with a high-potential cathode active material.

That is, the cathode active material preferably reaches 4.0 V or more of cathode potential in terms of sodium electrode potential in charging. The expression “reaches 4.0 V or more of cathode potential in terms of sodium electrode potential in charging” includes a case where a potential is applied until the cathode active material has 4.0 V or more of potential in charging the battery, even if the potential of the cathode active material after the charging is less than 4.0 V, in terms of sodium electrode potential. More preferably, the cathode active material reaches a cathode potential of 4.2 V or more when charging. Examples of such a high-potential cathode active material include composite oxides including Na and at least one of Co, Ni and Mn, and polyanion composite oxides including Na and at least one of PO₄, P₂O₇ and SO₄. More specifically, Na₄M₃ (PO₄)₂P₂O₇ (M is at least one of Fe, Ni, Co and Mn), Na_{2/3} (Fe_{1/2}Mn_{1/2})O₂, Na₂Fe₂ (SO₄)₃, NaCoO₂, Na_{2/3} (Ni_{1/3}Mn_{2/3})O₂ and the like are preferable. Among them, Na₄M₃ (PO₄)₂P₂O₇ (M is at least one of Fe, Ni, Co and Mn) is preferable and Na₄Co₃ (PO₄)₂P₂O₇ is especially preferable. Na₄M₃(PO₄)₂P₂O₇ (M is at least one of Fe, Ni, Co and Mn) is a high-potential cathode active material, and has electroconductive paths in three-dimensional directions because of its crystal structure. By using such a cathode active material, it is possible to obtain a sodium ion secondary battery having a high voltage and high energy density. It is also considered that, in the polyanionic cathode active material, the boron compound described later is adsorbed to the polyanionic parts, to adequately protect the cathode active material, whereby it is possible to adequately inhibit decomposition and degradation of the cathode active material in charging and discharging.

The shape of the cathode active material is preferably in a particle form. The average particle diameter (D₅₀) of the cathode active material is, for example, within a range from 1 nm to 100 μm, and preferably within a range from 10 nm to 30 μm. The content of the cathode active material in the cathode is not particularly limited, and for example, setting as 100 mass % the total amount of the electroconductive material and binder that are described later and cathode active material, preferably no less than 60 mass % and no more than 99 mass %, and more preferably no less than 70 mass % and no more than 95 mass %.

### 1.2. Electroconductive Material

Any kind of electroconductive material can be used without particular limitations, and any known electroconductive material for sodium ion secondary batteries can be employed. For example, a carbon material is preferable, and a carbon material having a high crystallinity is especially preferable. This is because if the crystallinity of the carbon material is high, Na ions get difficult to be inserted, whereby the irreversible capacity due to Na ion insertion can be reduced. As a result, it is possible to obtain a sodium ion secondary battery further excellent in a cycle characteristic. The crystallinity of a carbon material can be defined for example by the interlayer distance d002 and D/G ratio. The interlayer distance d002 is the surface distance of (002) surfaces in a carbon material, specifically the distance between the grapheme layers. The interlayer distance d002 can be obtained for example from a peak obtained by X-ray diffraction (XRD) using CuKα ray. D/G ratio is the peak intensity of D-band originated from the defect structure around 1350 cm⁻¹ to the peak intensity of G-band originated from the graphite structure around 1590 cm⁻¹, which is observed by means of Raman spectrometry (wave length of 532 nm). In the present disclosure, the upper limit of d002 is preferably 3.54 Å or less, and more preferably 3.50 Å or less for example. The lower limit is normally 3.36 Å or more. In addition, the upper limit of D/G ratio is preferably 0.90 or less, more preferably 0.80 or less, further preferably 0.50 or less, and still preferably 0.20 or less. The content of the electroconductive material in the cathode is not particularly limited.

### 1.3. Binder

The binder is not particularly limited as long as it is chemically and electrically stable. Example thereof include fluorine binders such as polyvinylidene fluoride (PVDF) and polytetrafluoroethylene (PTFE), rubber-based binders such as styrene butadiene rubber (SBR), olefinic binders such as polypropylene (PP) polyethylene (PE), cellulosic binders such as carboxymethylcellulose (CMC). The content of the binder in the cathode is not particularly limited.

The production method of the cathode layer is not particularly limited, and the cathode layer can be easily produced by a dry or wet method. That is, a cathode layer having a predetermined thickness (for example no less than 0.1 μm and no more than 1000 μm) can be easily produced by a wet method of: adding the above components to an adequate solvent to make slurry; applying the slurry on a surface of a base material (may be a cathode current collector or separator described later); thereafter drying the slurry. Alternatively, the cathode layer can be obtained by mixing the above components by a dry method, followed by press forming and the like.

### 1.4. Cathode Current Collector

The cathode is normally provided with a cathode current collector. Examples of the material for the cathode current collector include SUS, aluminum, nickel, iron, titanium and carbon. Examples of the shape of the cathode current collector include a foil, mesh and porous shape. The cathode can be easily produced by laminating the cathode current collector on the above-mentioned cathode layer. However, depending on the materials to be included in the cathode layer, the cathode current collector can be omitted. If the cathode current collector is omitted, the cathode layer itself will be a cathode.

### 2. Anode

As the anode, any known anode for sodium ion secondary batteries can be employed. The anode includes an anode active material. More specifically, in addition to the anode active material, the anode includes an anode layer which can optionally include an electroconductive material and a binder. Further, the anode is normally provided with an anode current collector.

### 2.1. Anode Active Material

The anode active material is not particularly limited, and any known anode active material for sodium ion secondary batteries can be employed. Examples thereof include: metal materials including sodium such as sodium metals and sodium alloys; carbon materials such as graphite, hard carbons and carbon black; sodium-transition metal composite oxides such as sodium titanate; oxides consisting of elements other than sodium such as SiOx. The anode active material is preferably in a particle form like the cathode active material.

### 2.2. Electroconductive Material and Binder

In the present disclosure, the electroconductive materials and binders which can be employed for the cathode can also be employed for the anode. The electroconductive material and binder are optional components, and their contents are not particularly limited either.

The production method of the anode layer is not particularly limited and can be easily produced by a dry or wet method like the cathode layer.

### 2.3. Anode Current Collector

The anode is normally provided with an anode current collector. Examples of the material for the anode current collector include SUS, nickel, copper and carbon. Examples of the shape of the anode current collector include a foil, mesh and porous shape. The anode can be easily produced by laminating the anode current collector on the above-mentioned anode layer. However, depending on the materials of the anode layer, the anode current collector can be omitted. If the anode current collector is omitted, the anode layer itself will be an anode.

### 3. Electrolytic Solution

The sodium ion secondary battery according to the present disclosure is provided with an electrolytic solution. The electrolytic solution includes a solvent and an electrolyte salt, and a predetermined boron compound is further added thereto.

### 3.1. Solvent

Examples of the solvent include organic solvents such as ethylene carbonate (EC), propylene carbonate (PC), dimethyl carbonate (DMC), diethyl carbonate (DEC), ethylmethyl carbonate (EMC) butylene carbonate (BC), γ-butyrolactone, sulfolane, acetonitrile, 1,2-dimethoxymethane, 1,3-dimethoxypropane, diethyl ether, tetrahydrofuran, 2-methyltetrahydrofuran, and mixture thereof. Among them, a mixture solvent of EC and DMC, a mixture solvent of EC and DEC, and a mixture solvent of EC and EMC are preferable. Alternatively, an ionic liquid can be used as the solvent.

### 3.2. Electrolyte Salt

As the electrolyte salt, any known electrolyte salt can be employed. Examples thereof include: inorganic sodium salts such as NaPF₆, NaBF₄, NaClO₄, and NaAsF₆; and organic sodium salts such as NaCF₃SO₃, NaPF₃(C₂F₅)₃, NaN(CF₃SO₂)₂, NaN(C₂F₅SO₂)₂, NaC(CF₃SO₂)₃, and NaN(FSO₂)₂. NaPF₆ is especially preferable. The concentration of the electrolyte salt in the electrolytic solution is preferably no less than 0.5 mol/L and no more than 2 mol/L. More preferably, the lower limit is 0.7 mol/L or more and the upper limit is 1.5 mol/L or less. That is, it is preferable that the concentration of the electrolyte is higher than the concentration of the compound including BF₄ anion described below.

### 3.3. Boron Compound

One or more kinds of boron compound selected from a compound represented by the following formula (1) and trifluoroborane is added to the electrolytic solution of the sodium ion secondary battery according to the present disclosure.

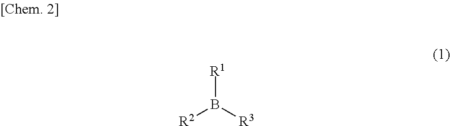

(In the formula (1), R¹, R² and R³ are independently a C₁-C₆ hydrocarbon group a part of which may be substituted by fluorine.)

In the above formula (1), R¹, R² and R³ are each independent substituent. R¹, R² and R³ may be the same or different. Preferably, R¹, R² and R³ are the same substituents. As the hydrocarbon group, a liner or branched alkyl group or an aryl group is preferable. In a case where R¹, R² and R³ are each an alkyl group, the carbon number thereof is 1 to 6, preferably 1 to 3, and more preferably 1 or 2. With the hydrocarbon group having a carbon number within such a range, steric hindrance by R¹, R² and R³ gets small, and the boron compound adequately adsorbs to the cathode or adequately binds with the acid in the electrolytic solution. In a case where R¹, R² and R³ are each an aryl group, the carbon number thereof is 6. That is, R¹, R² and R³ are each a phenyl group. In the present disclosure, R¹, R² and R³ may be partly substituted by fluorine.

Examples of the boron compound represented by the above formula (1) include trispentafluorophenylborane, trimethylborane, triphenylborane, triethyhlborane, tripropylborane, triisopropylborane, and tributylborane. With such a compound, it is possible to adequately protect the cathode without obstructing the charge-discharge reaction of the sodium ion secondary battery.

In the present disclosure, it is preferable that the boron compound is one or more kinds selected from trispentafluorophenylborane, triphenylborane, trimethylborane, triethyhlborane, and trifluoroborane. Among them, regarding a boron compound including fluorine (partly substituted by fluorine), electrons of boron tend to lack since fluorine in the molecular structure strongly attract the electrons of boron, which is considered to make the acid in the electrolytic solution and the boron compound bond with each other. On the other hand, in a case where the boron compound includes fluorine, the fluorine part of the boron compound and the electrolytic solution possibly react to each other to make a new acid, by repeated charging and discharging. Considering the former action, it is preferable to use trispentafluorophenylborane or trifluoroborane. Considering the latter action, it is preferable to use trimethylborane, triphenylborane, or triethyhlborane, and it is especially preferable to use triphenylborane. In view of having better economic efficiency and handling property, trimethylborane, triphenylborane, or triethyhlborane is preferable, and triphenylborane is further preferable.

The additive amount (concentration) of the boron compound in the electrolytic solution is not particularly limited, and preferably no less than 0.001 mol/L and no more than 0.2 mol/L. By having the additive amount within the above range, it is possible to further improve the cycle characteristic of the sodium ion secondary battery. The lower limit of the additive amount is preferably 0.002 mol/L or more, and more preferably 0.01 mol/L or more. The upper limit is preferably 0.1 mol/L or less, and more preferably 0.02 mol/L or less. According to the finding of the inventor of the present disclosure, if the amount of the boron compound is excessively large, the cycle characteristic tends to degrade. For example, the boron compound does not need to be added in a large amount as at the concentration of the electrolyte salt included in a conventional electrolytic solution. The boron compound shows a sufficient effect even though it is added in a small amount. That is, in the electrolyte solution, the concentration of the boron compound is preferably smaller than the concentration of the electrolyte salt.

According to the finding of the inventor of the present disclosure, it is found that the pH of the electrolytic solution increases if the sodium ion secondary battery is repeatedly charged and discharged. This is considered as a result of generation and increase of acid and water originated from the above-mentioned electrolyte salt and non-aqueous solvent. The electrolyte salt and non-aqueous solvent are generated in the charging, by oxidation decomposition of the electrolytic solution around the cathode. This acid decomposes the cathode active material in the cathode and degrades the cycle characteristic of the sodium ion secondary battery. This degradation of the cycle characteristic is noticeable especially when a high-potential cathode active material as mentioned above is used. In a case where NaPF₆ is used as the electrolyte salt of the electrolytic solution, it is considered that the acid described above is hydrogen fluoride. Here, in the present disclosure, the boron compound as described above is added to the electrolytic solution. Therefore, the boron compound adsorbs on the surface of the cathode active material to protect the cathode active material, or bonds with acid in the electrolytic solution such as hydrogen fluoride, whereby it is possible to inhibit decomposition of the cathode active material. As a result, it is possible to improve the cycle characteristic of the sodium ion secondary battery.

The electrolytic solution can be easily produced by adding an electrolyte salt and the above-described boron compound to a non-aqueous solvent. In the present disclosure, the sodium ion secondary battery can be made by introducing the electrolytic solution between the cathode and the anode. For example, the electrolytic solution can be adequately introduced between the cathode and the anode by: arranging a known separator (polyolefin (polyethylene or polypropylene) based porous film and the like) between the cathode and the anode; and immersing them in an electrolytic solution. Alternatively, an electrolyte gel can be made by adding a polymer (polyethylene oxide, polyacrylonitrile, polymethylmethacrylate and the like) to an electrolytic solution, to be arranged between the cathode and the anode. It is possible to easily produce the sodium ion secondary battery by housing the cathode, the anode and the electrolytic solution in an adequate case.

As described above, the present disclosure can have the same structure as that of a conventional sodium ion secondary battery, except that a boron compound is added to the electrolytic solution. According to the present disclosure, it is possible to provide a sodium ion secondary battery excellent in a cycle characteristic.

### EXAMPLES

Hereinafter the present disclosure will be described in detail based on Examples. However, the present disclosure is not limited to the following specific embodiments.

### 1. Production of Electrolytic Solution

Ethylene carbonate (EC) and diethyl carbonate (DEC) were mixed such that their volume ratio was EC:DEC=3:7. To the obtained mixture, NaPF₆ was added as an electrolyte salt at a concentration of 1 mol/L. Further, a boron compound (trispentafluorophenylborane (TPFPB), triphenylborane (TPB), trifluoroborane (TFB), trimethylborane (TMB), or triethylborane (TEB)) was added at the concentrations shown in Tables 1 to 3 described later. Whereby, electrolytic solutions according to Examples and Comparative Examples were produced.

### 2. Production of Cathode

Employed were Na₄Co₃ (PO₄)₂P₂O₇ as a cathode active material, acetylene black (AB) as an electroconductive material, and polyvinylidene fluoride (PVDF) as a binder. They were mixed and kneaded such that their mass ratio was cathode active material: electroconductive material:binder=85:10:5 to obtain a paste of cathode mixture. The obtained paste of cathode mixture was applied to an aluminum foil (whose thickness was 10 μm) with a doctor blade, then dried and pressed. Whereby, a cathode (50 μm of thickness) was produced on a cathode current collector.

### 3. Production of Anode

A metal sodium sheet having a thickness of 100 μm was used as an anode.

### 4. Production of Sodium ion Secondary Battery

A CR2032 coin cell was used. The above-mentioned cathode was punched in φ 16 mm and the above-mentioned anode was punched in φ18 mm. They were cut to match the shape of the cell. Between the cathode and the anode, a separator (φ20 mm (thickness 25 μm) of polyethylene/polypropylene/polyethylene porous separator) was arranged. The cathode, the separator, and the anode were housed in a case. Thereafter each of the above-mentioned electrolytic solutions was injected in the case, and the case was sealed. Whereby, sodium ion secondary batteries for evaluation were produced.

### 5. Evaluation of Cycle Characteristic of Sodium Ion Secondary Battery

The produced sodium ion secondary batteries were subjected to repeated charging and discharging under the following conditions, to calculate the maintenance rate (capacity maintenance rate) of the 1C discharging capacity after 50 cycles to the 1C discharging capacity at the first circle. Results are shown in Tables 1 and 2.

charging: CC4.8 V 1C(170 mAh/g=1C) 25° C.

discharging: CC3 V 1C(170 mAh/g=1C) 25° C.

TABLE 1

| | | additive | capacity |
|---|---|---|---|
| | kind of boron | concentration | maintenance rate |
| | compound | (mol/L) | after 50 cycles |
| Comparative | none | 0 | 42.0% |
| Example 1 | | | |
| Example 1 | TPFPB | 0.001 | 64.8% |
| Example 2 | TPFPB | 0.002 | 84.6% |
| Example 3 | TPFPB | 0.01 | 93.5% |
| Example 4 | TPFPB | 0.02 | 84.2% |
| Example 5 | TPFPB | 0.1 | 76.8% |
| Example 6 | TPFPB | 0.2 | 66.8% |

TABLE 2

| | | additive | capacity |
|---|---|---|---|
| | kind of boron | concentration | maintenance rate |
| | compound | (mol/L) | after 50 cycles |
| Comparative | none | 0 | 42.0% |
| Example 1 | | | |
| Example 7 | TPB | 0.001 | 64.0% |
| Example 8 | TPB | 0.002 | 77.4% |
| Example 9 | TPB | 0.01 | 94.2% |
| Example 10 | TPB | 0.02 | 86.7% |
| Example 11 | TPB | 0.1 | 78.9% |
| Example 12 | TPB | 0.2 | 68.1% |

TABLE 3

| | | additive | capacity |
|---|---|---|---|
| | kind of boron | concentration | maintenance rate |
| | compound | (mol/L) | after 50 cycles |
| Comparative | none | 0 | 42.0% |
| Example 1 | | | |
| Example 13 | TFB | 0.002 | 76.2% |
| Example 14 | TFB | 0.01 | 92.4% |
| Example 15 | TFB | 0.1 | 75.1% |
| Example 16 | TMB | 0.002 | 75.6% |
| Example 17 | TMB | 0.01 | 91.8% |
| Example 18 | TMB | 0.1 | 76.2% |
| Example 19 | TEB | 0.002 | 76.1% |
| Example 20 | TEB | 0.01 | 94.3% |
| Example 21 | TEB | 0.1 | 78.2% |

As shown in Tables 1 to 3, the followings were found: the cycle characteristic of a sodium ion secondary battery improved by adding a predetermined boron compound to the electrolytic solution: specifically, the cycle characteristic of a sodium ion secondary battery dramatically improved by making the concentration of the boron compound no less than 0.001 mol/L and no more than 0.2 mol/L: in addition, the cycle characteristic tended to slightly degrade if the amount of the boron compound was excessively large. For example, it was found that the boron compound did not need to be added in an amount as at the concentration of the electrolyte salt included in a conventional electrolytic solution, and shown a sufficient effect even though it was added at a small amount: and this tendency did not change regardless of the kind of the boron compound.

### INDUSTRIAL APPLICABILITY

The sodium ion secondary battery according to the present disclosure is excellent in a cycle characteristic, and can be preferably used as a large-sized on-vehicle power source and the like.

1. A sodium ion secondary battery comprising:
a cathode;
an anode; and
an electrolytic solution,
wherein
the cathode comprises a composite oxide comprising Na as a cathode active material;
the electrolytic solution comprises trifluroborane and one or more boron compounds represented by the following general formula (1): 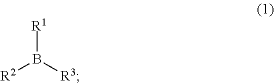
and
in the general formula (1), R¹, R² and R³ are independently a C₁-C₆ hydrocarbon group a part of which may be substituted by fluorine.

2. The sodium ion secondary battery according to claim 1, wherein no less than 0.001 mol/L and no more than 0.2 mol/L of the one or more boron compounds is added to the electrolytic solution.

3. The sodium ion secondary battery according to claim 1, wherein the one or more boron compounds is at least one of trispentafluorophenylborane, trimethylborane, triphenylborane, triethylborane, and trifluoroborane.

4. The sodium ion secondary battery according to claim 1, wherein the cathode active material reaches 4.0 V or more of cathode potential in terms of sodium electrode potential in charging.

5. The sodium ion secondary battery according to claim 1, wherein the cathode active material comprises at least one of Co, Ni, and Mn.

6. The sodium ion secondary battery according to claim 1, wherein the cathode active material comprises at least one of PO₄, P₂O₇, and SO₄.

7. The sodium ion secondary battery according to claim 6, wherein the cathode active material is Na₄M₃(PO₄)₂P₂O₇ (M is at least one of Fe, Ni, Co, and Mn).

8. The sodium ion secondary battery according to claim 1, wherein the electrolytic solution includes NaPF₆ or NaBF₄ as an electrolyte salt.
